(19) United States
(12) Patent Application Publication
(10) Pub. No.: US 2023/0233988 A1
(43) Pub. Date: Jul. 27, 2023

(54) DEVELOPMENT OF THE ABSORPTION PROCESS IN THE DIFFERENT INDUSTRIES

(71) Applicant: Mohamed Hasan Soliman ABD ELMOEZ, Minia (EG)

(72) Inventor: Mohamed Hasan Soliman ABD ELMOEZ, Minia (EG)

(21) Appl. No.: 18/010,536

(22) PCT Filed: May 18, 2021
(86) PCT No.: PCT/EG2021/000014

§ 371 Date: Dec. 15, 2022

(30) Foreign Application Priority Data
Jun. 17, 2020 (EG) 2020060866

(51) Int. Cl. B01D 53/18; B01D 47/10; B01D 53/14; B01D 53/60; B01D 53/62; B01D 53/78

(52) U.S. Cl. CPC B01D 53/18; B01D 47/10; B01D 53/1475; B01D 53/60; B01D 53/62; B01D 53/78; B01D 2252/103; B01D 2257/302; B01D 2257/404; B01D 2257/504; B01D 2258/0283

(57) ABSTRACT

Absorption, or gas absorption, is a unit operation used in the chemical industries to separate gases by washing or scrubbing a gas mixture with a suitable liquid. Gas absorption is usually carried out in vertical countercurrent columns The solvent is fed in at the top of the absorber, the gas mixture from the bottom. We developed the process to get high yield and high efficiency.

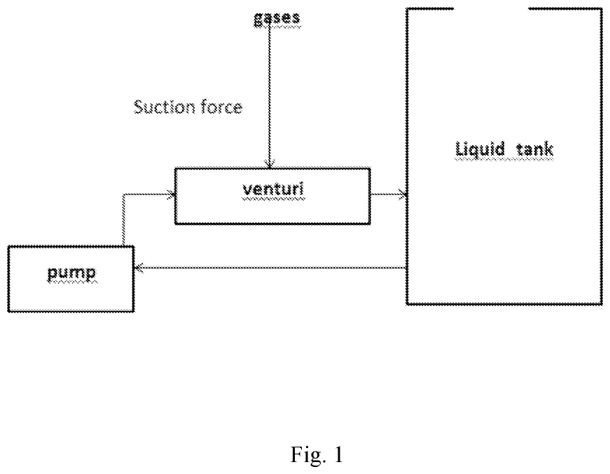

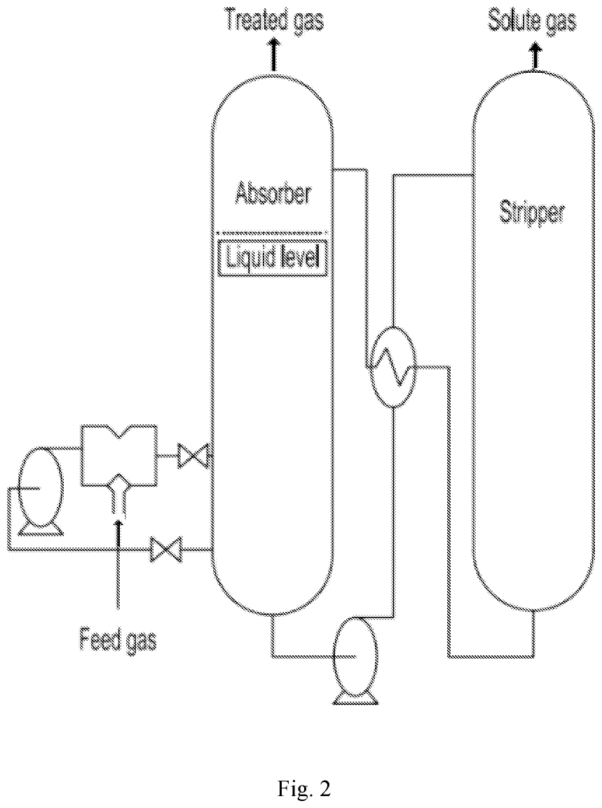

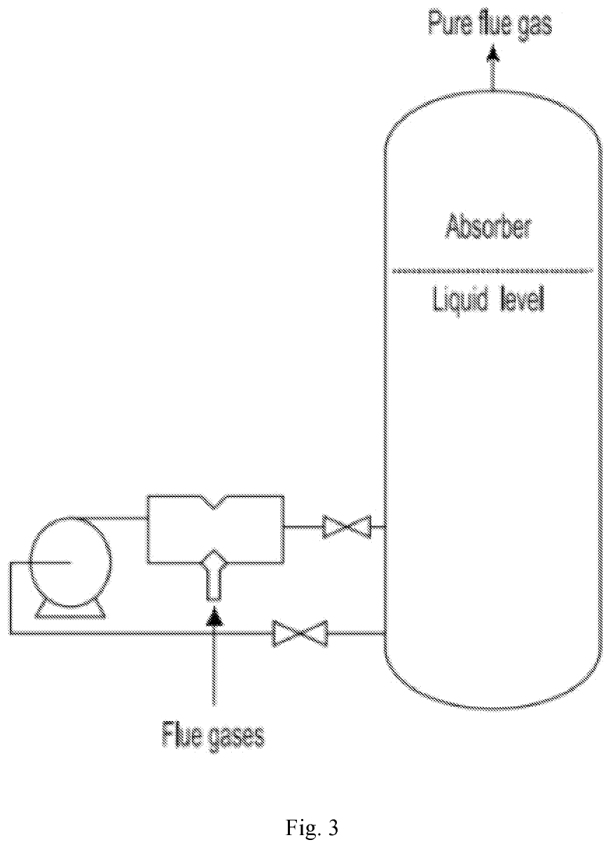

Absorption, or gas absorption, is a unit operation used in the chemical industry to separate gases by washing or scrubbing a gas mixture with a suitable liquid. One or more of the constituents of the gas mixture dissolves or is absorbed in the liquid and can thus be removed from the mixture. In some systems, this gaseous constituent forms a physical solution with the liquid or the solvent, and in other cases, it reacts with the liquid chemically. The purpose of such scrubbing operations may be gas purification, eg, removal of air pollutants from exhaust gases; product recovery; or production of solutions of gases for various purposes. Gas absorption is usually carried out in vertical countercurrent columns. The solvent is fed in at the top of the absorber, the gas mixture from the bottom. The absorbed substance is washed out by the solvent, which is often recovered in a subsequent stripping or desorption operation. The absorber may be a packed column, plate tower, or simple spray column, or a bubble column. The fundamental physical principles underlying the process of gas absorption are the solubility of the absorbed gas and the rate of mass transfer.

For the pollution one of the main challenges in the power and chemical industries is to remove generated toxic or environmentally harmful gases before atmospheric emission. To comply with stringent environmental and pollutant emissions control regulations, Cost-effective and sustainable technologies for the reduction of such pollutants from flue gas have become increasingly important nowadays.

The flue gases out of burning wastes may contain particulate matter, heavy metals, dioxins, sulfur dioxide, and nitrogen oxides

Water soluble gases are removed effectively in wet and dry absorption but dry scrubbers require an excess of chemicals for a high removal efficiency. Wet scrubbers normally require special treatment of the waste water.

Selective non-catalytic reduction (SNCR) and selective catalytic reduction (SCR) methods are available for the removal of nitrogen oxides (NOₓ).

### NOₓ Reduction Technologies

NOₓ is the generic term used to refer to nitrogen oxides (NO and NO₂), which are primarily produced during the combustion of hydrocarbons in the presence of air. Nitrogen and oxygen gases in the air combine to form oxides of nitrogen when exposed to extremely high heats (>2800° F.). When NOₓ, gases are released into the atmosphere, they dissolve in the natural moisture and form a weak nitric acid solution (acid rain). When NOₓ mixes with volatile organic compounds and reacts with sunlight they form photochemical smog.

While NOₓ can be formed naturally during lightning strikes, the primary anthropogenic sources of these gases are from gasoline combustion in automobiles and the combustion of fossil fuels during the generation of electricity.

NOₓ reduction technologies (as they relate to electricity generation) are aimed at reducing the temperatures in boilers to keep heat below the levels at which NOₓ is formed. They also will decrease or increase the amounts (or percentages) of excess air in the boiler to control NOₓ production.

Technology for removal of high levels of NOₓ in the form of either selective catalytic reduction (SCR) or selective non-catalytic reduction (SNCR). Both technologies, however, have limitations. These include potential compromise of the catalyst when treating dirty gas steams, process disruption, plant shut-down or lower levels of performance in NOₓ removal

### Flue-Gas Desulfurization

In flue gas from fossil-fuel power plants can be controlled Sulfur dioxide by means of an absorption process called flue gas desulfurization (FGD). FGD systems may involve wet scrubbing or dry scrubbing. In wet FGD systems, flue gases are brought in contact with an absorbent, which can be either a liquid or a slurry of solid material. The sulfur dioxide dissolves in or reacts with the absorbent and becomes trapped in it. In dry FGD systems, the absorbent is dry pulverized lime or limestone; once absorption occurs, the solid particles are removed by means of baghouse filters. Dry FGD systems, compared with wet systems, offer cost and energy savings and easier operation, but they require higher chemical consumption and are limited to flue gases derived from the combustion of low-sulfur coal.

The disadvantages of the absorber
Poor mass transfer.
Cannot handle extremely high or low flow rates
Short gas residence time

The Air pollution control technology for flue gas out of burning fuel or wastes like (sewage sludge, municipal solid waste) or flue gases out of chemicals, petrochemical industries and other industries are expensive and hard, polluted gases releases to the atmosphere because of the weakness of the absorption process

### For Removal of NOₓ

Technology for removal of high levels of NOₓ in the form of either selective catalytic reduction (SCR) or selective non-catalytic reduction (SNCR). Both technologies, however, have limitations. These include potential compromise of the catalyst when treating dirty gas steams, process disruption, plant shut-down or lower levels of performance in NOₓ removal.

For Flue-gas desulfurization process the disadvantages are
1—high capital and operating costs
2—scaling and deposit of wet solids on absorber and downstream equipment
3—wet systems generate a wet waste product and may result in a visible plume
4—cannot be used for waste gas SO2 concentrations greater than 2,000 ppm
5—disposal of waste products significantly increases the Operation and Maintenance.

Dry FGD systems, compared with wet systems, offer cost and energy savings and easier operation, but they require higher chemical consumption and are limited to flue gases derived from the combustion of low-sulfur coal.

### DISCLOSURE OF INVENTION

Replace the absorption unit in the different industries by injection the gases in liquid by using venturi system as illustrated in the image below.

we could use the venturi system instead of absorber in the chemical, fertilizer, pollution control (using venturi system for the flue gases), petrochemical and fertilizer industries and other applications.

Control in the water pressure to control the suction force to be optimum to enable it to withdraw the gas without effect in the process

By this method we could develop the absorption unit in the industries and make a method with high mass transfer, high gas residence time and can handle high flow rate, this help in the increasing the yield and the efficiency in the different industries and make high effect in the air pollution control because with this method we could prevent more harmful gases from release to the environment.

In the flue gases, collection the co2 after this treatment and connect it by pipelines to the greenhouses, in the industries like cement, energy, waste incineration, it will affect in the climate change

Gas absorption is usually carried out in vertical countercurrent columns. The solvent is fed in at the top of the absorber, the gas mixture from the bottom. This unit has disadvantages like Poor mass transfer, Cannot handle extremely high or low flow rates and short gas residence time so we made a method to get high efficiency.

### The Method

Replace the absorption unit in the different industries by injection the gases in liquid by using venturi system as illustrated in the image below.

We could use the venturi system instead of absorber in the chemical, fertilizer, pollution control (using venturi system for the flue gases), petrochemical and fertilizer industries and other applications.

For the venturis system Controlling the liquid pressure to control the suction force to be optimum to enable it to withdraw the gas without effect in the process

By this method we could develop the absorption unit in the industries and make a method with high mass transfer, high gas residence time and can handle high flow rate this help in the increasing the yield and the efficiency in the different industries and make high effect in the air pollution control because with this method we could prevent more harmful gases from release to the environment

In the flue gases, collection the co2 after this treatment and connect it by pipelines to the greenhouses, in the industries like cement, energy, waste incineration, it will affect in the climate change.

Analysis of flue gases out of incineration after the treatment by the system show the high efficiency of the system

TABLE
Concentration of different stack emissions (mg/m³) for Boilers insider
Company Name: Eng. Mohamed Hassan
Date of Measurements: January 2021
Sampling Point: Stack of incineration

| | | Maximum Permissible Limits according |
|---|---|---|
| | | to law No. 4 for 1994 for environment |
| | | protection and its amendments by law |
| | Measured | No. 9 for 2009 and its executive |
| Parameter | Value | regulation board issued in 2011 and 2015 |
| T (° C.) | 190 | |
| CO (mg/m³) | 2 | 100 |
| SO2 (mg/m³) | 0 | 150 |
| NOx (mg/m³) | 1 | 500 |
| Total Particulate | 3 | 50 |
| (mg/m³) | | |
| O₂ | 13.5% | |
| Efficiency | 99.6% | |

### The Applications of the Invention

This method will use in the different industries like Chemical industries. Fertilizer industries, pollution control units, petrochemical industries and other applications

Applications which use the absorption unit.
*ammonia plants co2 removal absorption process: this system can save 15-20% of solvent recirculation. Saving 15-20% of stripper energy, saving packing cost. Saving promoter cost and permit the plant to increase the capacity by 5-10%.
*dehydration and sweetness of natural gas: this system can save 15-20% of solvent recirculation. Saving 15-20% of stripper energy, saving packing cost and increasing the capacity of gas processing.
*emission control: this system can give us high efficiency, protect the environment and facing the climate change by using less capital cost and operating cost.

### BRIEF DESCRIPTION OF THE DRAWING

FIG. (1): the basic design for absorber show the suction of the gas resulted from the venturi effect.

FIG. (2): using the absorber in absorption and stripping system.

FIG. (3): using the absorber in treatment flue gases and pollution control.

1. Absorption system for absorbing one or more constituents of a gas mixture, wherein the one or more constituents of the gas mixture are absorbed in a liquid in a liquid tank, wherein said system comprises said liquid tank, a pump and a venturi system coupled to said liquid tank and the pump, wherein the venturi system is arranged for injecting the gas mixture into the liquid in said venturi system and to inject the mixture into said liquid tank below the liquid level, wherein the liquid tank comprises an outlet to the pump and the venturi system is coupled to the liquid tank above said outlet to inject the gas mixture into the liquid in said tank above said outlet.

2. Absorption system according to claim 1, wherein the venturi system is arranged for injecting the gas mixture into the liquid in said liquid tank from the bottom of said liquid tank and further comprising a stripping system arranged for recovering the liquid in said liquid tank in a stripping operation

3. Method for absorbing one or more constituents of a gas mixture, wherein the one or more constituents of the gas mixture are absorbed in a liquid in a liquid tank, wherein said method comprises:
providing an absorption system according to claim 1;
providing liquid in the venturi system;
injecting the gas mixture in the liquid using the venturi system.

4. Method according to claim 4, further comprising:
injecting the gas mixture, injected in the liquid using the venturi system, into the liquid tank from the bottom of said liquid tank.

5. Method according to claim 4, further comprising:
injecting the gas mixture, injected in the liquid using the venturi system, into the liquid tank below a liquid level in the liquid tank.
recovering the liquid in said liquid tank in a stripping operation subsequent to injecting the gas mixture in the liquid using the venturi system.

6. Method according to claim 5, further comprising:
injecting the gas mixture, injected in the liquid using the venturi system, into the liquid tank below a liquid level in the liquid tank.
recovering the liquid in said liquid tank in a stripping operation subsequent to injecting the gas mixture in the liquid using the venturi system.
